(19) United States
(12) Patent Application Publication
(10) Pub. No.: US 2006/0162747 A1
(43) Pub. Date: Jul. 27, 2006

(54) Polypro scrap accumulator

(76) Inventors: Mike Belleville, Garden Grove, CA (US); Bill Ryczek, La Vevne, CA (US); Craig Miller, La Mirada, CA (US)

Correspondence Address: Neil E. Hamilton;JohnsonDiversey, Inc., 8310 16th Street, P.O. Box 902 (MS 509), Sturtevant, WI, 53177-0902, US

(21) Appl. No.: 11/042,761

(22) Filed: Jan. 25, 2005

(51) Int. Cl. B08B 3/00; B08B 3/04

(52) U.S. Cl. 134/56 D; 134/58 D; 134/104.2; 134/104.4

(57) ABSTRACT

A kitchenware washing apparatus having an improved scrap accumulator. The scrap accumulator is composed of a molded plastic material to provide efficient drainage and secure retention in the kitchenware washing apparatus. The scrap accumulator is produced at a lower cost than one made of metal.

### CROSS-REFERENCES TO RELATED APPLICATIONS, IF ANY

None.

### STATEMENT REGARDING FEDERALLY SPONSORED RESEARCH OR DEVELOPMENT

None.

### BACKGROUND OF THE INVENTION

1. Technical Field

This invention relates generally to kitchenware washing apparatus and more particularly to kitchenware washing apparatus which employ scrap accumulators.

2. Background Art

There are available a wide variety of kitchenware washing machines. These machines employ scrap accumulators for the purpose of reducing the amounts of solid wastes from the washing process from entering the drain system.

The use of scrap accumulators in conjunction with kitchenware washing machines or food processing machines are described in U.S. Pat. Nos. 2,627,863 and 4,440,185. These scrap accumulators are made of metal. Metal fabrication involves cutting, bending, punching, welding and grinding to fabricate such an accumulator. These procedures are costly. Further, with a metal fabricated accumulator, the accumulation of food particles trapped within the corners of the accumulator are common and therefore present a potential health hazard in addition to the undesirable odor of old food.

Further, metal fabricated scrap accumulators can bend when contacted with a trash can to dislodge food particles. Also, metal fabricated scrap accumulators can easily vibrate loose from a kitchenware washing machine.

Thus, there is a need for a scrap accumulator for kitchenware washing machines which overcomes the problems of food particle accumulation, bending, vibrating loose from the machine, as well as being economical to produce.

The objects of the invention therefore are:

a. Providing an improved kitchenware washing apparatus.

b. Providing a kitchenware washing apparatus which affords an efficient removal of food particles from the drain water.

c. Providing an improved scrap accumulator for a kitchenware washing apparatus.

d. Providing a scrap accumulator for a kitchenware washing apparatus which affords improved drainage.

e. Providing a scrap accumulator of the foregoing type which affords improved retention in the kitchenware washing machine.

f. Providing a scrap accumulator of the foregoing type which can be produced in an economical manner.

### SUMMARY OF THE INVENTION

The foregoing objects are accomplished and the shortcomings of the prior art are overcome by the kitchenware washing apparatus of this invention which includes a cabinet for receiving the kitchenware. A fluid output member is operatively connected to the cabinet for the delivery and removal of cleaning water. A scrap accumulator member is operatively connected to the cabinet. The scrap accumulator has a flow path therethrough. The scrap accumulator has a flow path therethrough. The accumulator member includes a base portion which is sloped to a drain. A particle accumulator member is slideably connected to the scrap accumulator member. The scrap accumulator member and the particle accumulator member are composed of a molded plastic material.

In a preferred embodiment, the base portion of the accumulator member includes oppositely positioned rails to receive the particle accumulator member, the rails including ramps constructed and arranged to retain the particle accumulator member in the base portion.

In one aspect, the particle accumulator member includes apertures having smaller and larger dimensions, with the larger dimension facing upwardly and with the apertures having a triangular configuration.

In another aspect, the particle accumulator member includes a screen.

### BRIEF DESCRIPTION OF THE DRAWINGS

FIG. 1 is a side view of a kitchenware washing apparatus connected to the particle accumulator;

FIG. 2 is a perspective view of the particle accumulator;

FIG. 3 is a view similar to FIG. 2 with the lid of the particle accumulator removed;

FIG. 4 is a view similar to FIG. 2 illustrating the screen member partially removed;

FIG. 5 is an enlarged partial view of the screen member shown in FIG. 4;

FIG. 6 is a partial enlarged view of a ramp for engagement with the screen member; and

FIG. 7 is a cross-sectional view of the body member of the particle accumulator.

### DESCRIPTION OF THE PREFERRED EMBODIMENTS

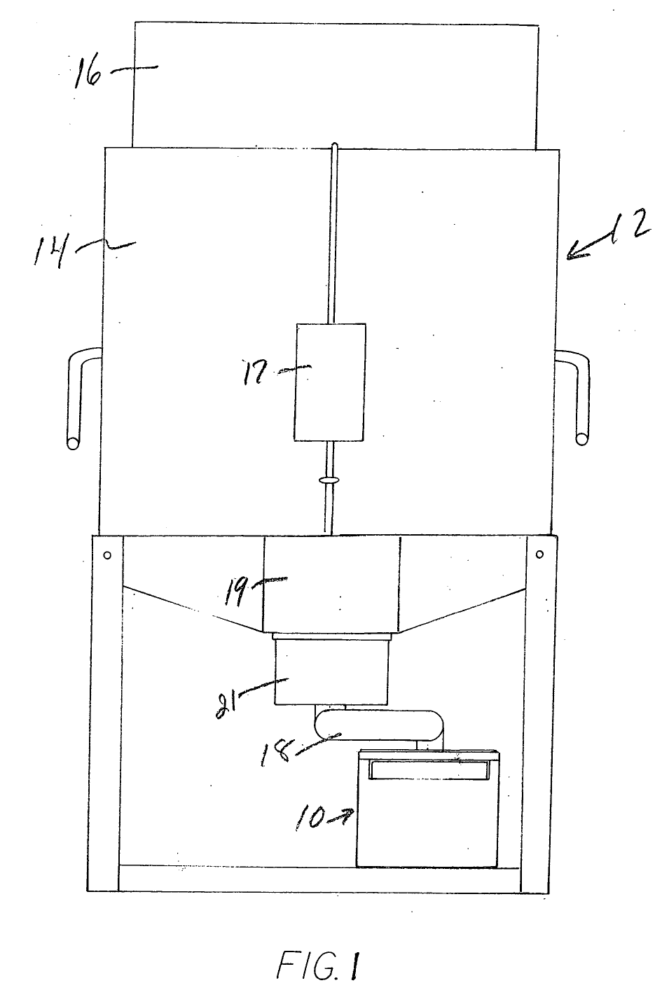

As seen in FIG. 1, the scrap accumulator generally 10 of this invention is shown in conjunction with a standard kitchenware washing apparatus generally 12 such as the Model EVA-C supplied by CMA Dishmachines located in Garden Grove, Calif. This machine includes a cabinet 14 and a control panel 16 as well as the usual solenoid valve 17, sump 19 and drain casting 21. A drain line 18 for emptying cleaning water into the scrap accumulator 10 is connected to drain casting 21.

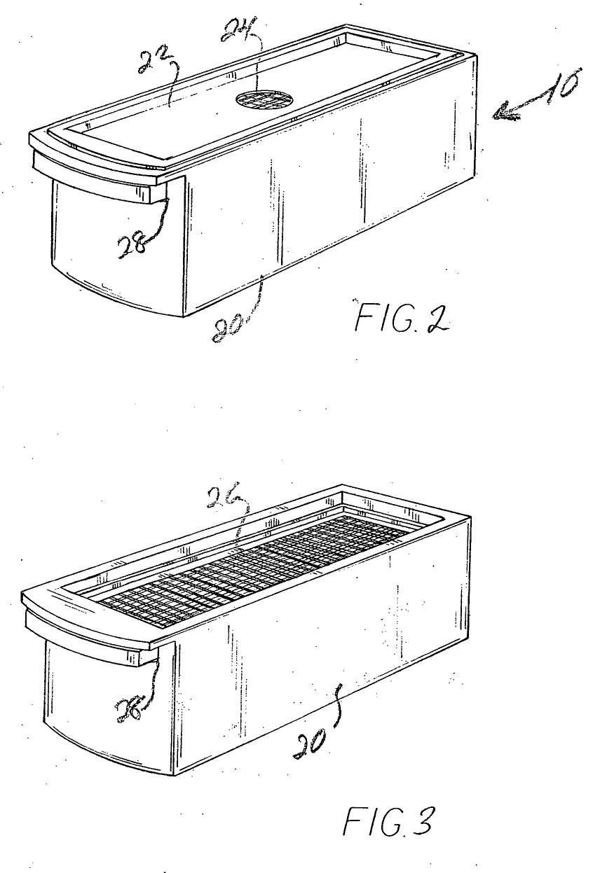

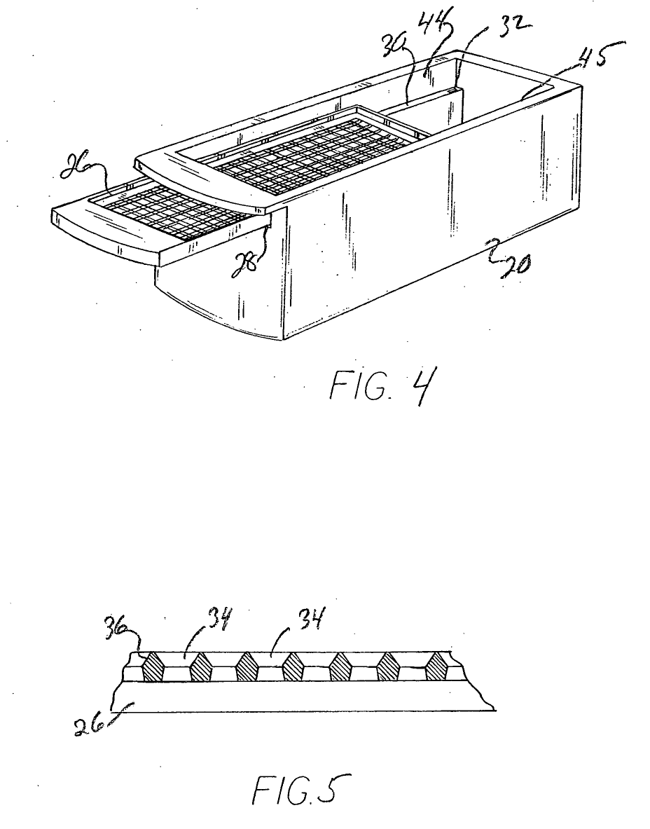

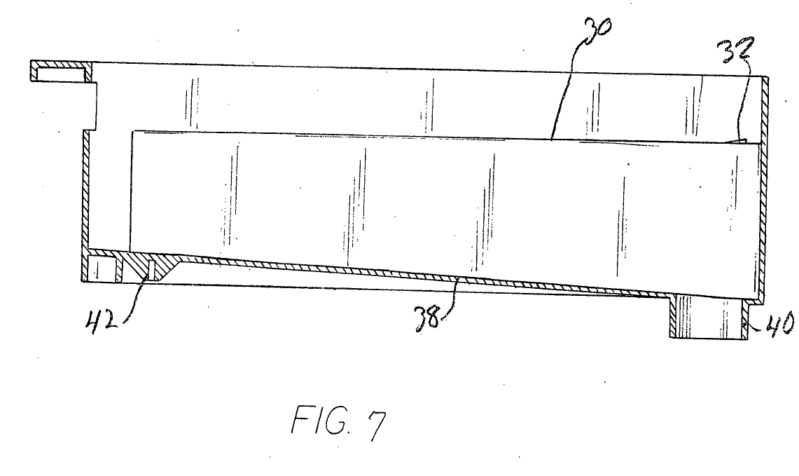

Referring to FIGS. 2-4, the scrap accumulator 10 includes a body member 20 with a lid 22 having an opening 24 for communicating with drain line 18. A screen member 26 is slideably supported in the body member 20 by means of the slot 28 and two oppositely positioned rail members, one of which is shown at 30. See also FIGS. 6 and 7.

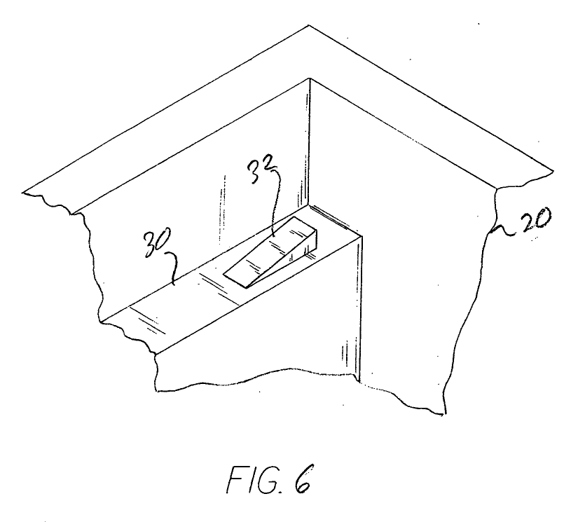

As seen in FIG. 5, screen member 26 is composed of rib members 36 which are of a triangular shape on the top surface. This provides apertures 34 having smaller and larger dimensions with the larger dimensions facing upwardly. This provides an impact surface for water to divert it in a downward motion to prevent water particles from accumulating on the floor or base portion 38, as seen in FIG. 7.

Referring to FIG. 6, there is shown a ramp member 32 positioned on rail member 30. This provides a retention feature for screen member 26. As stated previously there are two rail members adjacent opposite walls 44 and 45 of body member 20. This is indicated in FIG. 4.

As seen in FIG. 7, body member 20 has a base portion 38 which slopes toward drain 40. This allows for efficient drainage of water and any particles which pass through the screen member 26. A boss 42 is provided in base portion 28 for the purpose of securing body member 20 to the machine.

An important feature of the scrap accumulator 10 is that it is molded from a plastic material with polypropylene being preferred. This plastic construction eliminates the problems of metal fabrication which involve cutting, bending, punching, welding and grinding. This also allows for a sloped floor which is very expensive to create in a metal unit. Further, a plastic bodied accumulator is resilient to abuse, such as denting, scratching, etc.

Polypropylene has been indicated as the preferred plastic material for fabricating the accumulator. However, other plastic materials such as polyethylene, nylon, or other similar plastic materials, could be employed.

The scrap accumulator has been described in conjunction with a particular kitchenware washing apparatus. It is obvious that it can be employed with any kitchenware washing apparatus having a drain for waste water. Also, while preferred embodiments have been described for the scrap accumulator, this invention is not to be limited except as set forth in the following claims.

What is claimed is:

1. A kitchenware washing apparatus comprising:
a cabinet for receiving the kitchenware;
a fluid output member operatively connected to the cabinet for the delivery and removal of a cleaning fluid;
a scrap accumulator member operatively connected to the cabinet, the scrap accumulator having a flow path therethrough, the accumulator member including a base portion which is sloped to a drain; and
a particle accumulator member slideably connected to the scrap accumulator member, the scrap accumulator member and particle accumulator member composed of a molded plastic material.

2. The kitchenware washing apparatus as defined in claim 1 wherein the base portion includes oppositely positioned support rail members to receive the particle accumulator member, the rail members including ramps constructed and arranged to retain the particle accumulator member in the base portion.

3. The kitchenware washing apparatus as defined in claim 1 wherein the particle accumulator member includes apertures having smaller and larger dimensions, with the larger dimension facing upwardly when placed in the accumulator.

4. The kitchenware washing apparatus as defined in claim 3 wherein the apertures are of a triangular configuration having smaller and larger dimensions, with the larger dimension facing upwardly when placed in the accumulator.

5. The kitchenware washing apparatus as defined in claim 4 wherein the particle accumulator member includes a screen.

6. The kitchenware washing apparatus as defined in claim 1 wherein the molded plastic material is polypropylene.

7. The kitchenware washing apparatus as defined in claim 1 wherein the scrap accumulator member is connected to the outside of the cabinet.

8. A scrap accumulator for use in a kitchenware washing apparatus comprising:
at least one side wall;
a floor portion with a drain opening, the floor being sloped toward the drain;
a particle accumulator connected to the side wall;
the side wall and floor portion being composed of a molded plastic material.

9. The scrap accumulator as defined in claim 8 wherein the particle accumulator is composed of a molded plastic material.

10. The scrap accumulator as defined in claim 8 wherein the particle accumulator includes apertures having smaller and larger dimensions with the larger dimensions facing upwardly when placed in the accumulator.

11. The scrap accumulator as defined in claim 10 wherein the apertures are of a triangular configuration.

12. The scrap accumulator as defined in claim 10 wherein the particle accumulator is in the form of a screen.
